(19) United States
(12) Patent Application Publication
(10) Pub. No.: US 2023/0064195 A1
(43) Pub. Date: Mar. 2, 2023

(54) TRAVELING VIDEO PROVIDING SYSTEM, APPARATUS, AND METHOD

(71) Applicant: NEC Corporation, Minato-ku, Tokyo (JP)

(72) Inventor: Kyohei NARITA, Tokyo (JP)

(73) Assignee: NEC Corporation, Minato-ku, Tokyo (JP)

(21) Appl. No.: 17/800,301

(22) PCT Filed: Mar. 12, 2020
(86) PCT No.: PCT/JP2020/010885

§ 371 Date: Aug. 17, 2022

(51) Int. Cl. G06F 16/787; G06V 20/56; G01C 21/34

(52) U.S. Cl. CPC G06F 16/787; G06V 20/56; G01C 21/3407

(57) ABSTRACT

A video collection server receives traveling videos captured by a plurality of vehicles and stores the traveling videos and position information about positions where the traveling videos are captured in a traveling video database. A video search unit of the video providing server searches the traveling video database when the video distribution request is received from a user, and acquires the traveling video(s) captured by the vehicle traveling in each of one or more sections included in the designated route. A traveling video synthesis unit synthesizes the traveling video of each section. A video distribution unit distributes the synthesized traveling video to a user apparatus as the traveling video when the vehicle travels along the route.

### TECHNICAL FIELD

The present disclosure relates to a traveling video providing system, apparatus, method, and computer readable medium.

### BACKGROUND ART

In recent years, there has been an increase in the number of vehicles each equipped with a dashboard camera for capturing an area in front of the vehicle while the vehicle is traveling. An information processing system described in Patent Literature 1 is known as a related technique for utilizing videos captured by dashboard cameras. In the information processing system described in Patent Literature 1, a user (client) requests an image shared server to share image data. At this time, the user transmits request information including an address indicating a captured place, a capturing start time, and a capturing end time to the shared server. When the user wants to track a vehicle that has fled from an accident scene, the user can designate a fleeing route and request the shared server to share image data captured by dashboard cameras of vehicles traveling along the route.

The shared server transmits search information corresponding to the request information to each vehicle. An image recording apparatus of the vehicle uploads the image data of the dashboard camera satisfying a condition indicated in the search information to the shared server. For example, when the vehicle travels along the route designated in the request information, the image recording apparatus uploads image data captured while the vehicle is traveling along the route to the shared server. The shared server transmits the image data uploaded from the vehicle to an image display apparatus of the user. The image display apparatus plays back moving image data received from the shared server.

As another related technique, Patent Literature 2 discloses a video distribution apparatus. The video distribution apparatus according to Patent Literature 2 provides a user with a video image captured using cameras mounted on a vehicle. In Patent Literature 2, the train is equipped with a camera for capturing scenes from a driver's seat, a camera for capturing a vehicle window from a passenger seat, and a camera for capturing a state inside a passenger cabin. A video distribution server receives data captured by the cameras from the train and accumulates the captured data.

The user designates a desired train to the video distribution apparatus. The video distribution apparatus distributes the captured data of the designated train to a user terminal apparatus. When the train arrives at a transferable station in the captured data, a transfer icon is displayed on the user terminal apparatus. The user can designate another train, a route bus, or the like as a transfer destination vehicle at the transfer station. When the user designates a transfer, the video distribution server distributes captured data such as a train of a transfer destination to the user terminal apparatus. By doing so, the user can experience virtual reality similar to an actual transfer.

### CITATION LIST

### Patent Literature

Patent Literature 1: Japanese Unexamined Patent Application Publication No. 2016-103049
Patent Literature 2: Japanese Unexamined Patent Application Publication No. 2004-236267

### SUMMARY OF INVENTION

### Technical Problem

In Patent Literature 1, the user can view dashboard camera videos of the vehicles traveling in a place included in the route designated by the user in a designated range of periods of time. However, in Patent Literature 1, image data (dashboard camera video) of each vehicle is individually displayed. Therefore, if there is no vehicle traveling along the route that perfectly matches the designated route, the user cannot view a series of image data from a starting point to an end point of the route.

In Patent Literature 2, videos of trains, buses and other vehicles traveling along the predetermined route are distributed. Therefore, the user cannot view videos of vehicles traveling along the route optionally designated by the user.

In view of the above circumstances, an object of the present disclosure is to provide a traveling video providing system, apparatus, method, and a computer readable medium capable of displaying a video of a vehicle traveling along a route designated by a user as a series of image data.

### Solution to Problem

In order to achieve the above object, in an example aspect of the present disclosure, a traveling video providing system includes: a video collection server configured to receive traveling videos captured by a plurality of vehicles and store the traveling videos and position information about positions where the traveling videos are captured in a traveling video database; a video providing server configured to receive a video distribution request including information designating a route and distribute the traveling videos to a user when a vehicle travels along the route designated in the video distribution request; and a user apparatus configured to receive and display the distributed traveling video. The video providing server includes: traveling video search means for searching the traveling video database when the video distribution request is received from the user, and acquiring the traveling video(s) captured by the vehicle traveling in each of one or more sections included in the designated route; traveling video synthesis means for synthesizing the traveling video of each section included in the route; and video distribution means for distributing the synthesized traveling video to the user apparatus as the traveling video when the vehicle travels along the route.

In another example aspect of the present disclosure, a traveling video providing apparatus includes: traveling video search means for searching, when a video distribution request including information designating a route is received from a user, a traveling video database configured to store traveling videos captured by a plurality of vehicles and position information about positions where the traveling videos are captured, and acquiring a traveling video(s) captured by vehicles traveling in one or more sections included in the designated route; traveling video synthesis means for synthesizing the traveling video of each section included in the route; and video distribution means for distributing the synthesized traveling video to a user apparatus as the traveling video when a vehicle travels along the route.

In another example aspect of the present disclosure, a traveling video providing method includes: searching, when a video distribution request including information designating a route is received from a user, a traveling video database configured to store traveling videos captured by a plurality of vehicles and position information about positions where the traveling videos are captured, and acquiring a traveling video(s) captured by vehicles traveling in one or more sections included in the designated route; synthesizing the traveling video of each section included in the route; and distributing the synthesized traveling video to a user apparatus as the traveling video when a vehicle travels along the route.

In another example aspect of the present disclosure, a non-transitory computer readable medium storing a program causes a computer to execute processing of: searching, when a video distribution request including information designating a route is received from a user, a traveling video database configured to store traveling videos captured by a plurality of vehicles and position information about positions where the traveling videos are captured, and acquiring a traveling video(s) captured by vehicles traveling in one or more sections included in the designated route; synthesizing the traveling video of each section included in the route; and distributing the synthesized traveling video to a user apparatus as the traveling video when a vehicle travels along the route.

### Advantageous Effects of Invention

A traveling video providing system, apparatus, method, and a computer readable medium can display a video of a vehicle traveling along a route designated by a user as a series of image data.

### BRIEF DESCRIPTION OF DRAWINGS

FIG. 1 is a block diagram showing an overview of a traveling video providing system according to the present disclosure;

FIG. 2 is a block diagram showing a traveling video providing system according to an example embodiment of the present disclosure;

FIG. 3 is a block diagram showing a configuration example of a video providing server;

FIG. 4 shows an example of video conditions;

FIG. 5 is a flowchart showing an operation procedure of the traveling video providing system while videos are being collected;

FIG. 6 is a flowchart showing an operation procedure of a traveling video providing system when a traveling video is being provided;

FIG. 7 is an overview diagram showing an example of a part of a route designated by a user and a traveling route of each vehicle;

FIG. 8 is a schematic diagram showing a traveling video obtained from a traveling video DB and then synthesized;

FIG. 9 is a schematic diagram showing a part of the route designated by the user and another example of a traveling route for each vehicle;

FIG. 10 is a schematic diagram showing a traveling video obtained from the traveling video DB and then synthesized; and

FIG. 11 is a block diagram showing a configuration example of a computer apparatus.

### EXAMPLE EMBODIMENT

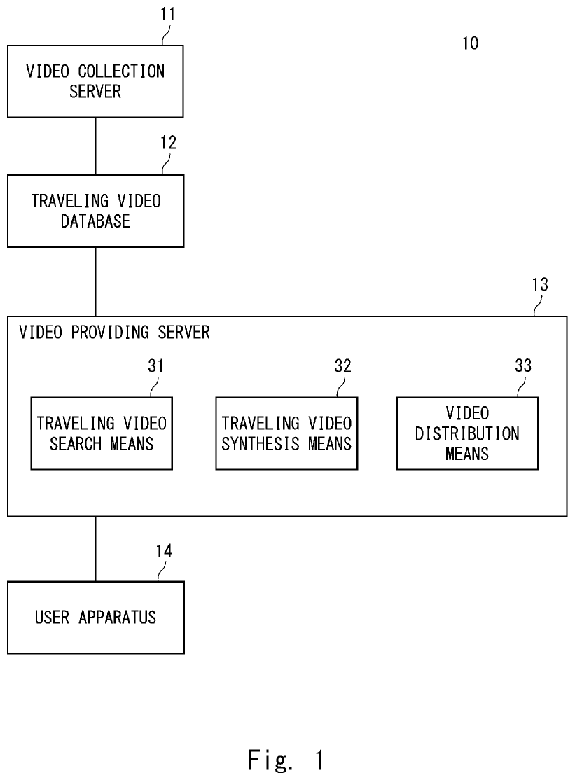

Prior to the description of example embodiments of the present disclosure, an overview of the present disclosure will be described. FIG. 1 shows an outline of a traveling video providing system according to the present disclosure. A traveling video providing system 10 includes a video collection server 11, a video providing server 13, and a user apparatus 14. The video providing server 13 includes traveling video search means 31, traveling video synthesis means 32, and image distribution means 33.

The video collection server 11 receives traveling videos captured by a plurality of vehicles. The video collection server 11 stores the traveling videos and position information about a position where the traveling videos are captured in the traveling video database 12. The video providing server 13 receives, from a user, a video distribution request including information for designating a route. The video providing server 13 distributes, to the user, the traveling video when a vehicle travels along the route designated in the video distribution request. The user apparatus 14 displays the distributed traveling video.

In the video providing server 13, when the video distribution request is received from the user, the traveling video search means 31 searches the traveling video database 12 in accordance with the video distribution request. The traveling video search means 31 acquires, from the traveling video database 12, the traveling videos captured by the vehicles traveling in one or more sections included in the designated route. The traveling video synthesis means 32 synthesizes the traveling videos of the respective sections included in the route. The video distribution means 33 distributes the synthesized traveling video to the user apparatus 14 as the traveling video when the vehicle travels along the route.

In the present disclosure, the traveling video search means 31 acquires, from the traveling video database 12, the traveling video of each section included in the route. The traveling video synthesis means 32 synthesizes the traveling videos of the respective sections. The video distribution means 33 distributes the synthesized traveling video to the user apparatus 14. In the present disclosure, since the traveling videos of the respective sections are synthesized, even when there is no vehicle traveling along the route designated by the user, the video of the vehicle traveling along the route designated by the user can be displayed as a series of image data.

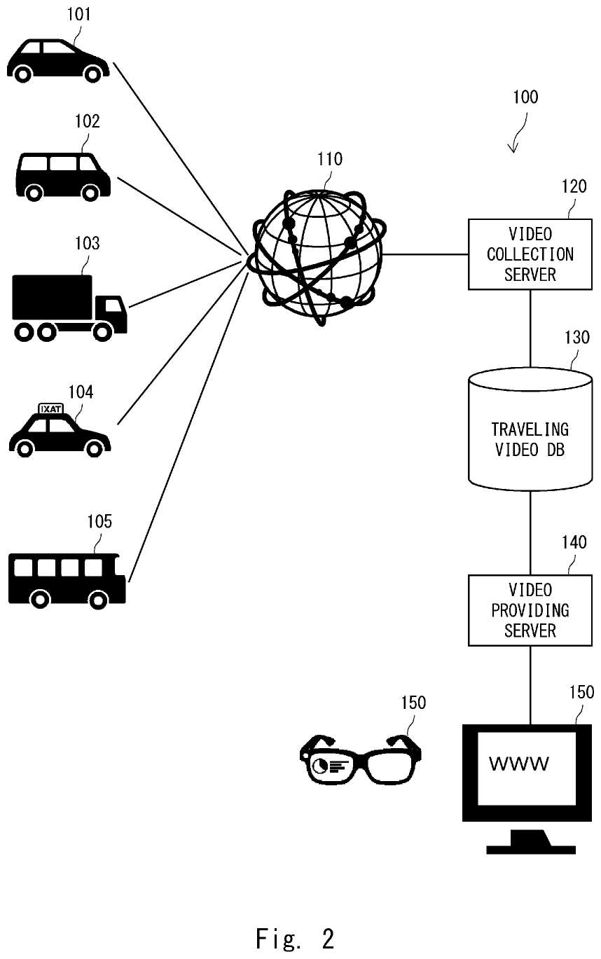

Example embodiments of the present disclosure will now be described in detail with reference to the drawings. FIG. 2 shows a traveling video providing system according to an example embodiment of the present disclosure. A traveling video providing system 100 includes a video collection server 120, a traveling video DB (database) 130, a video providing server 140, and a user apparatus 150. The traveling video providing system 100 corresponds to the traveling video providing system 10 of FIG. 1.

Each of vehicles 101 to 105 is mounted with a camera for capturing at least an area in front of the vehicle (a direction in which the vehicle moves forward). For example, the vehicle 101 is a private vehicle, the vehicle 102 is a van, the vehicle 103 is a truck, the vehicle 104 is a taxi, and the vehicle 105 is a bus. Each vehicle transmits a traveling video captured by using the camera to the video collection server 120 via a network 110 such as the Internet.

The video collection server 120 collects videos (traveling videos) of cameras mounted on the vehicles from an unspecified number of vehicles via the network 110. The video collection server 120 stores the collected traveling videos in a traveling video DB 140. The video collection server 120 stores the traveling video received from each vehicle in the traveling video DB 140 in association with information such as position information and a traveling direction. The video collection server 120 corresponds to the video collection server 11 of FIG. 1, and the traveling video DB 140 corresponds to the traveling video database 12 of FIG. 1.

The user apparatus 150 is used by a user who wishes to distribute the traveling video. The user apparatus 150 is configured as an apparatus such as a computer apparatus, a smartphone, or a tablet having a communication function. The user apparatus 150 includes a display apparatus capable of displaying moving images. The display apparatus may be configured as an apparatus such as, for example, a wearable display or a head-mounted display.

The user transmits a video distribution request to the video providing server by using the user apparatus 150. The video distribution request includes information for designating a route of a traveling video the user wants to be provided with and information for designating video conditions. The user accesses the video providing server 140 via, for example, the Internet, and designates the route and the video conditions on the web page provided by the video providing server 140. The user apparatus 150 corresponds to the user apparatus 14 in FIG. 1.

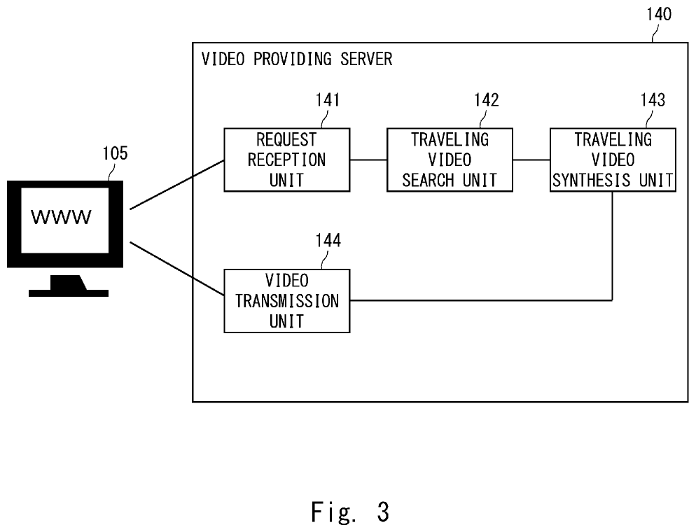

FIG. 3 shows a configuration example of the video providing server (a traveling video providing apparatus) 140. The video providing server 140 includes a request reception unit 141, a traveling video search unit 142, a traveling video synthesis unit 143, and a video transmission unit 144. The request reception unit 141 receives the video distribution request from the user apparatus 150.

The traveling video search unit 142 searches the traveling video DB 120 (see FIG. 2) based on the route designated in the video distribution request and the video conditions. The traveling video search unit 142 divides the route into, for example, one or more sections. The traveling video search unit 142 checks whether or not there is a traveling video captured by a vehicle traveling in each section in the traveling video DB 120. When there is a traveling video, the traveling video search unit 142 acquires, from the traveling video DB 120, a traveling video satisfying the video conditions designated in the video distribution request among the traveling videos in each section. The traveling video search unit 142 may acquire a traveling video with the latest travel date and time when there are a plurality of traveling videos satisfying the video conditions in each section. The traveling video search unit 142 corresponds to the traveling video search means 31 shown in FIG. 1.

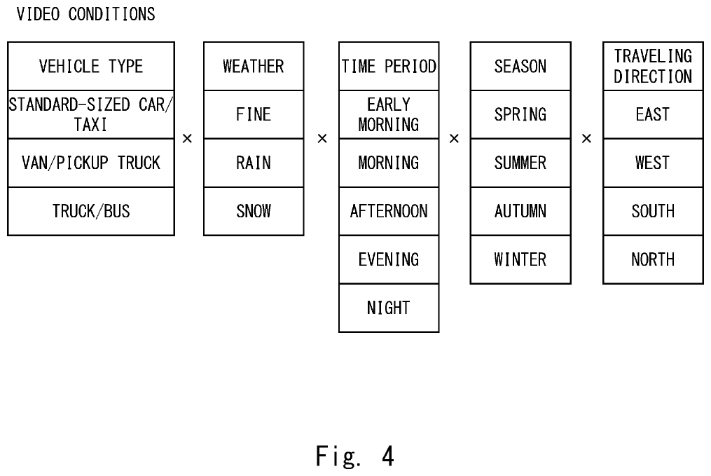

FIG. 4 shows an example of the video conditions. The video conditions include, for example, a vehicle type, weather, a time period, season, and a traveling direction. The vehicle types include, for example, “standard-sized car/taxi”, “van/pickup truck”, and “truck/bus”. The weather includes “fine”, “rain”, and “snow”. The time periods include “early morning (e.g., 5:00-9:00 AM)”, “morning (e.g., 9:00-13:00)”, “afternoon (e.g., 13:00-17:00)”, “evening (e.g., 17:00-19:00)”, and “night (e.g., 19:00-5:00 AM)”. The seasons include “spring (e.g., April-June)”, “summer (e.g., July-September)”, “autumn (e.g., October-December)”, and “winter (e.g., January-March)”. The traveling directions include “East”, “West”, “South”, and “North”. The video conditions need not include all of the vehicle types, weather, time periods, seasons, and traveling directions, and may instead include at least one of them.

The user designates, for example, the video conditions in which the vehicle type is “standard-sized car/taxi”, the weather is “fine”, the time period is “morning”, the season is “winter”, and the traveling direction is “south”. In this case, the traveling video search unit 142 acquires, for each section of the route from the traveling video DB 120, a traveling video in which the vehicle type corresponds to a standard-sized car or the like, the weather is fine, the time indicates morning, the date indicates winter, and the traveling direction is south when a vehicle is traveling. For example, the traveling video DB 120 stores the traveling video in association with attribute information such as the weather, the date and time, and the traveling direction. The traveling video search unit 142 may identify the weather, the time period, the season, and the traveling direction by referring to the attribute information.

The traveling video synthesis unit 143 synthesizes the traveling videos of the respective sections acquired by the traveling video search unit 142. For example, by synthesizing the traveling videos of vehicles of the same vehicle type in the respective sections, it is possible to synthesize images (videos) having similar viewpoints (distances between the camera and the ground surface). In addition, by synthesizing the traveling videos of the same weather in the respective sections, it is possible to synthesize the images having close illuminance. By synthesizing the traveling videos in the respective sections in the same time period, it is possible to synthesize images having close luminous intensities and the close directions pointed by light. By synthesizing the traveling videos of the same season in the respective sections, it is possible to synthesize images having close sceneries. The traveling video synthesis unit 143 corresponds to the traveling video synthesis means 32 shown in FIG. 1.

The video transmission unit 144 distributes the traveling video synthesized by the traveling video synthesis unit 143 to the user apparatus 150 as the traveling video when the vehicle travels along the route from a starting point to a destination point. The video transmission unit 144 streams, for example, the synthesized traveling video to the user apparatus 150. The video transmission unit 144 corresponds to the video distribution means 33 shown in FIG. 1.

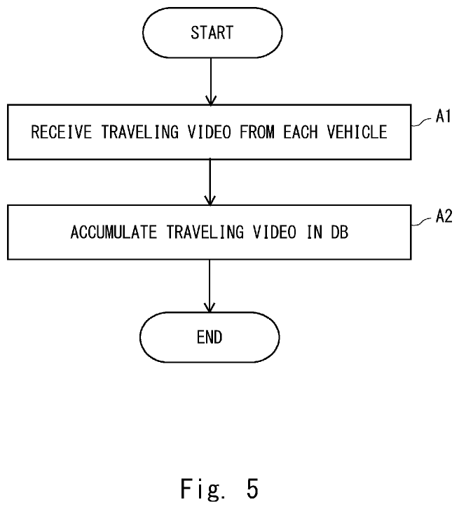

Next, an operation procedure will be described. The operation of the traveling video providing system is roughly divided into video collection and traveling video provision. FIG. 5 shows an operation procedure of the traveling video providing system at the time of video collection. Each of the vehicles 101 to 105 transmits, to the video collection server 120, the traveling video captured by using the mounted camera and information such as the position information, identification information of the vehicle, and the vehicle type. The video collection server 120 collects the traveling videos from the plurality of vehicles 101 to 105 via the network 110 (Step A1). The video collection server 120 stores the collected traveling videos in the traveling video DB 130 in association with the position information, the date and time, the direction, and the like (Step A2).

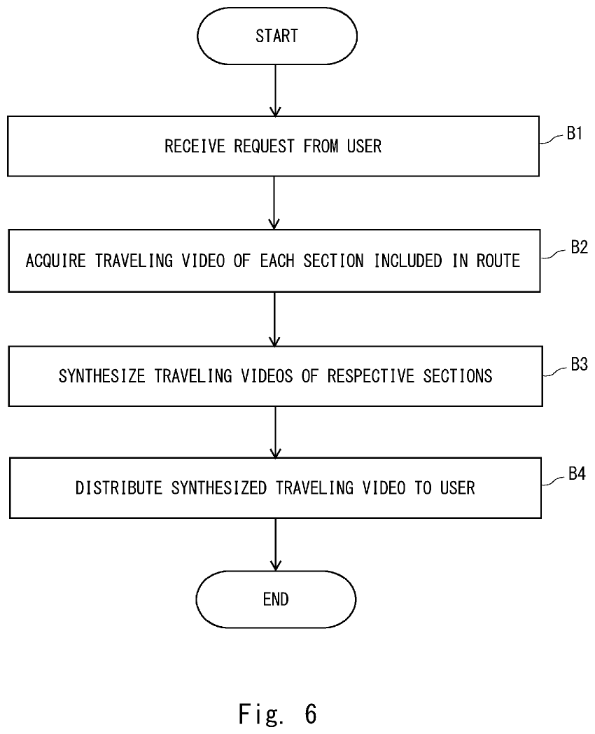

FIG. 6 shows an operation procedure (a traveling video providing method) in providing the traveling video. The user operates the user apparatus 150 and designates the video conditions including the route for viewing a traveling video, a vehicle type, and the like. The user designates, for example, a starting point and a destination point. The user may optionally designate a point to pass between the starting point and the destination point, or the user apparatus 150 or the video providing server 140 may automatically determine such a point in accordance with a route search algorithm or the like. The request reception unit 141 of the video providing server 140 receives the video distribution request from the user apparatus 150 (Step B1).

The traveling video search unit 142 divides the route designated in the video distribution request into a plurality of sections. The traveling video search unit 142 divides the route into a plurality of sections at each branch point such as an intersection. The traveling video search unit 142 searches the traveling video DB 120 based on the position information and the video conditions of each section, and acquires the traveling videos of the respective sections included in the route from the traveling video DB 120 (Step B2). The traveling video synthesis unit 143 synthesizes the traveling videos of the respective sections (Step B3). The video transmission unit 144 distributes the synthesized traveling video to the user apparatus 150 (Step B4). An operating body of the traveling video providing system 100 may be paid by the user for the distribution of the traveling video.

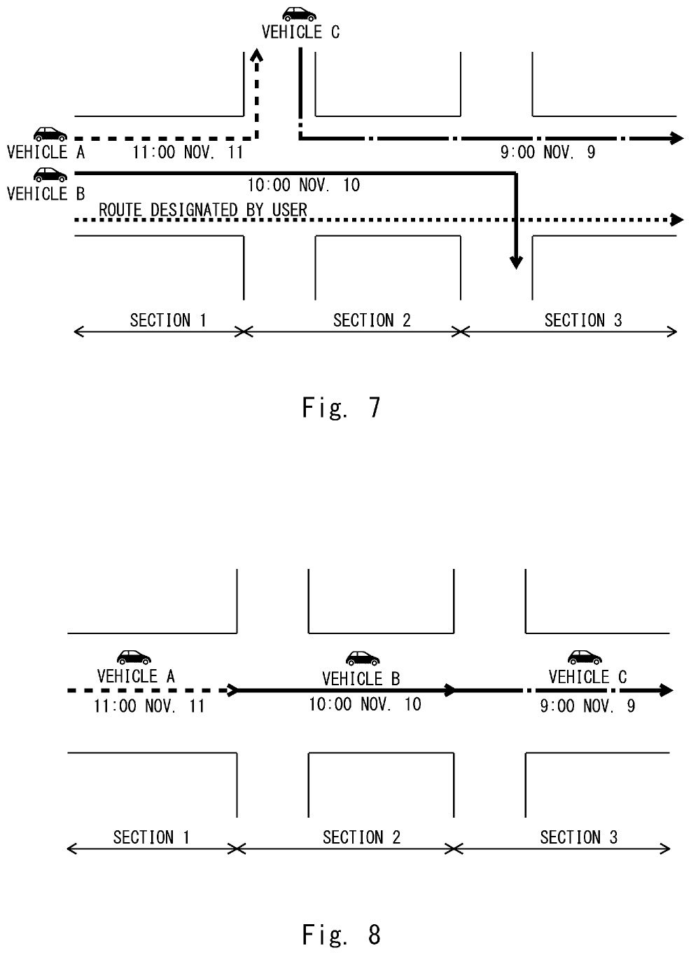

Hereinafter, the acquisition of the traveling videos of the respective sections and the synthesis of the traveling videos will be described with reference to specific examples. FIG. 7 shows a part of the route designated by the user and an example of the traveling route of each vehicle. Here, it is assumed that the route designated by the user in the video distribution request includes a section 1, a section 2, and a section 3. It is also assumed that the user designates the standard-sized car as the vehicle type in the video distribution request.

In FIG. 7, as shown by the broken line, a vehicle A travels through the section 1 toward the section 2, turns left at the intersection, and heads to a point outside the route designated by the user. As shown by the solid line, a vehicle B travels through the sections 1 and 2 toward the section 3, turns right at the intersection, and heads to a point outside the route designated by the user. As shown by the dashed line, a vehicle C enters the section 2 from the outside of the route and travels through the section 3. It is assumed that vehicles A, B, and C are all standard-sized cars. It is assumed that the date and time when the vehicle A has driven through the section 1 is 11:00 AM on November 11. It is also assumed that the date and time when the vehicle B have traveled through the sections 1 and 2 is 10:00 AM on November 10. It is also assumed that the date and time when the vehicle C has driven through the section 3 is 9:00 AM on November 9.

FIG. 8 shows traveling videos acquired from the traveling video DB 120 and then synthesized. The traveling video DB 120 stores a traveling video of the vehicle A and a traveling video of the vehicle B for the section 1. In this case, the traveling video search unit 142 acquires the traveling video of the vehicle A with the new travel date and time as the traveling video in the section 1. The traveling video DB 120 stores the traveling video of the vehicle B and the traveling video of the vehicle C in the section 2. The traveling video search unit 142 acquires the traveling video of the vehicle B having a new travel date and time as a traveling video in the section 2. The traveling video search unit 142 acquires the traveling video of the vehicle C as the traveling video in the section 3, because the vehicle C is the only vehicle traveling in the section 3 in FIG. 7. The traveling video synthesis unit 143 synthesizes the traveling video of the car A in the section 1, the traveling video of the car B in the section 2, and the traveling video of the car C in the section 3 into one traveling video.

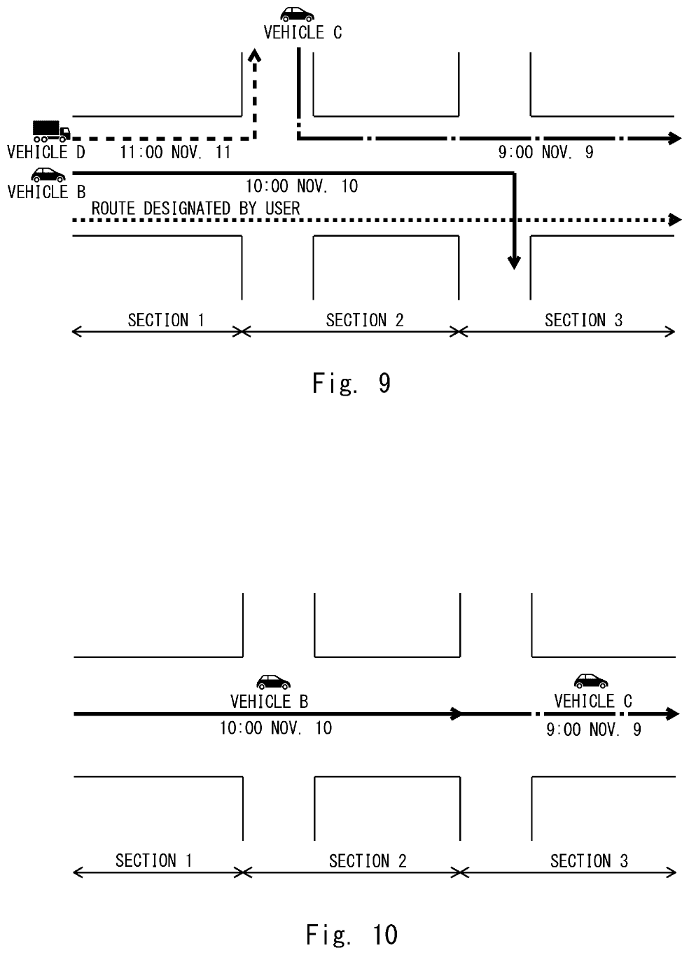

FIG. 9 shows a part of the route designated by the user and another example of the traveling route of each vehicle. In FIG. 9, as shown by the broken line, a vehicle D travels through the section 1 toward the section 2, turns left at the intersection, and heads to a point outside the route designated by the user. A traveling route of the vehicle D and the traveling route of the vehicle A in FIG. 7 are the same. It is assumed that the vehicle type of the vehicle D is a truck. It is also assumed that the date and time when the vehicle D has driven through the section 1 is 11:00 AM on November 11. The traveling route and the traveling date and time of the vehicles B and C are the same as those in the example of FIG. 7.

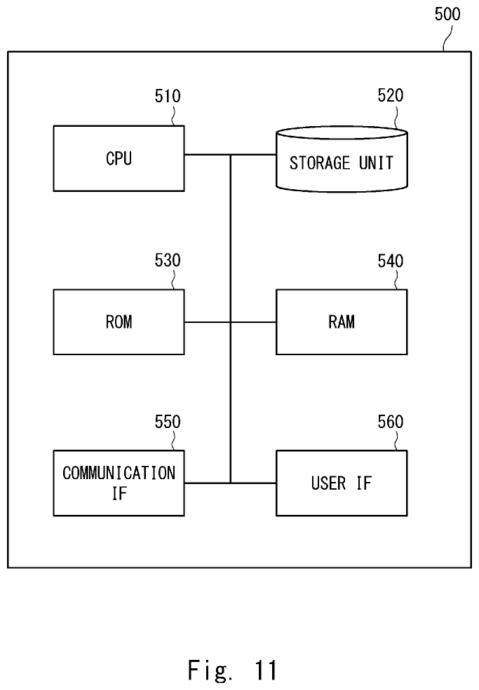

FIG. 10 shows traveling videos acquired from the traveling video DB 120 and then synthesized. The traveling video DB 120 stores the traveling video of the vehicle D and traveling video of the vehicle B in the section 1. When a standard-sized car is designated as the vehicle type, the traveling video search unit 142 acquires the traveling video of the vehicle B as the traveling video in the section 1. As in the example of FIG. 8, the traveling video DB 120 acquires the traveling video of the vehicle B having a new travel date and time as the traveling video in the section 2. The traveling video search unit 142 acquires the traveling video of the car C as the traveling video in the section 3. In this case, the traveling video synthesis unit 143 synthesizes the traveling videos of the vehicle B in the sections 1 and 2 and the traveling video of the vehicle C in the section 3 into one traveling video.

In this example embodiment, the traveling video search unit 142 acquires traveling videos in the respective sections included in the route designated by the user from the traveling video DB 130 that can store traveling videos collected from many unspecified vehicles. The traveling video synthesis unit 143 synthesizes traveling videos in the respective sections, and the video transmission unit 144 distributes, to the user apparatus 150, the synthesized traveling video as a series of the traveling videos. In this way, the user can view the video image traveling between specified points.

Further, in this example embodiment, the user can designate the vehicle type and the like as the video conditions. The traveling video search unit 142 acquires traveling videos of the same type of a vehicle for each section of the route, so that the user can view, for example, a traveling video in which the heights of the viewpoints are aligned.

The traveling video providing system 100 may be used, for example, in the following situations. The user designates a starting point and a destination point in an area where he or she visited for the first time in a trip or the like, and transmits a video distribution request to the video providing server 140. At this time, the user designates the same type of a vehicle as that of the vehicle driven by the user as the video condition. By viewing the distributed traveling video, the user can simulate driving experience in advance from the same viewpoint as that of his or her own vehicle type before actually driving the vehicle in an area that the user has never visited.

Note that the traveling video synthesis unit 143 may perform image processing for changing the viewpoint of the video on the traveling video in a certain section while synthesizing traveling videos. The traveling video synthesis unit 143 may synthesize the traveling video of the section in which the viewpoint is changed with the traveling video of another section. For example, for a certain section, there is a case where there is no traveling video of a vehicle of the type designated in the video condition in the traveling video DB 130. In this case, the traveling video search unit 142 may acquire a traveling video of a vehicle of a type different from the vehicle type designated in the video condition for the section. For example, when the designated vehicle type is “standard-sized car” and the traveling video DB 130 includes only the traveling video of the vehicle type “truck” for a certain section, the traveling video search unit 142 may acquire the traveling video of the “truck”. The traveling video synthesis unit 143 may perform image processing for lowering the viewpoint of the traveling video of the “truck”. The traveling video synthesis unit 143 may synthesize the traveling video in which the viewpoint is lowered with the traveling video of the “standard-sized car” in another section. Also in this case, the positions of the viewpoints of the traveling videos to be synthesized can be aligned.

Next, physical configurations of the video collection server 120 and the video providing server 140 will be described. FIG. 11 shows a configuration example of a computer apparatus that can be used as the video collection server 120 and the video providing server 140. A computer apparatus 500 includes a control unit (CPU: Central Processing Unit) 510, a storage unit 520, a ROM (Read Only Memory) 530, a RAM (Random Access Memory) 540, a communication interface (IF) 550, and a user interface 560.

The communication interface 550 is for connecting the computer apparatus 500 and the communication network via wire communication means or wireless communication means. The user interface 560 includes a display unit such as a display. The user interface 560 also includes an input unit such as a keyboard, mouse, and touch panel.

The storage unit 520 is an auxiliary storage device capable of holding various types of data. The storage unit 520 need not necessarily be a part of the computer apparatus 500, and instead may be an external storage device or a cloud storage device connected to the computer apparatus 500 via a network. The storage unit 520 may be used, for example, as the traveling video DB 130 shown in FIG. 2.

The ROM 530 is a non-volatile storage device. The ROM 530 is a semiconductor memory device such as a flash memory having a relatively small capacity. Programs executed by the CPU 510 may be stored in the storage unit 520 or the ROM 530. The storage unit 520 or the ROM 530 stores, for example, various programs for implementing the functions of the respective units in the video collection server 120 or the video providing server 140.

The above programs can be stored and provided to the computer apparatus 500 using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), optical disk medium such as CD (compact disc) and DVD (digital versatile disk), and semiconductor memories (such as mask ROM, PROM (programmable ROM), EPROM (erasable PROM), flash ROM, RAM, etc.). The programs may be provided to the computer using any type of transitory computer readable media.

Examples of transitory computer readable media include electric signals, optical signals, and electromagnetic waves. Transitory computer readable media can provide the programs to the computer via a wired communication line (e.g. electric wires, and optical fibers) or a wireless communication line.

The RAM 540 is a volatile storage device. Various semiconductor memory devices such as a DRAM (Dynamic Random Access Memory) or an SRAM (Static Random Access Memory) are used as the RAM 540. The RAM 540 may be used as an internal buffer for temporarily storing data and the like. The CPU 510 expands the programs stored in the storage unit 520 or the ROM 530 into the RAM 540 and executes it. The functions of each unit in the video collection server 120 or the video providing server 140 can be implemented by the CPU 510 executing the program. The CPU 510 may have an internal buffer that can temporarily store data or the like.

Although the example embodiments of the present disclosure have been described above in detail, the present disclosure is not limited to the above-described example embodiments, and changes or modifications to the above-described example embodiments are also included in the present disclosure to the extent that they do not depart from the spirit of the present disclosure.

The whole or part of the example embodiments disclosed above can be described as, but not limited to, the following supplementary notes.

### [Supplementary Note 1]

A traveling video providing system comprising:

a video collection server configured to receive traveling videos captured by a plurality of vehicles and store the traveling videos and position information about positions where the traveling videos are captured in a traveling video database;

a video providing server configured to receive a video distribution request including information designating a route and distribute the traveling videos to a user when a vehicle travels along the route designated in the video distribution request; and

a user apparatus configured to receive and display the distributed traveling video, wherein

the video providing server comprises:
traveling video search means for searching the traveling video database when the video distribution request is received from the user, and acquiring the traveling video(s) captured by the vehicle traveling in each of one or more sections included in the designated route;
traveling video synthesis means for synthesizing the traveling video of each section included in the route; and
video distribution means for distributing the synthesized traveling video to the user apparatus as the traveling video when the vehicle travels along the route.

### [Supplementary Note 2]

The traveling video providing system according to Supplementary note 1, wherein

the video distribution request further includes information for designating a video condition, and

the traveling video search means acquires a traveling video satisfying the video condition from among the traveling videos captured by each of the vehicles traveling in one or more sections included in the route.

### [Supplementary Note 3]

The traveling video providing system according to Supplementary note 2, wherein

the video conditions include at least one of a vehicle type, weather, a time period, a season, or a traveling direction.

### [Supplementary Note 4]

The traveling video providing system according to Supplementary note 2 or 3, wherein

the traveling video search means acquires a latest traveling video among the plurality of traveling videos when there are a plurality of traveling videos satisfying the video condition in the traveling video database.

### [Supplementary Note 5]

The traveling video providing system according to any one of Supplementary notes 1 to 4, wherein

the traveling video search means divides the route into a plurality of sections and acquires the traveling video for each section from the traveling video database.

### [Supplementary Note 6]

The traveling video providing system according to Supplementary note 5, wherein

the traveling video search means divides the route into a plurality of sections at each branch point.

### [Supplementary Note 7]

The traveling video providing system according to any one of Supplementary notes 1 to 5, wherein the user apparatus includes a wearable or head-mounted display apparatus.

### [Supplementary Note 8]

The traveling video providing system according to any one of Supplementary notes 1 to 7, wherein

the traveling video synthesis means performs image processing for changing a viewpoint of the video on the traveling video of one section, and synthesizes the traveling video of the one section having the changed viewpoint with the traveling video of another section.

### [Supplementary Note 9]

A traveling video providing apparatus comprising:

traveling video search means for searching, when a video distribution request including information designating a route is received from a user, a traveling video database configured to store traveling videos captured by a plurality of vehicles and position information about positions where the traveling videos are captured, and acquiring a traveling video(s) captured by vehicles traveling in one or more sections included in the designated route;

traveling video synthesis means for synthesizing the traveling video of each section included in the route; and

video distribution means for distributing the synthesized traveling video to a user apparatus as the traveling video when a vehicle travels along the route.

### [Supplementary Note 10]

The traveling video providing system according to Supplementary note 9, wherein

the video distribution request further includes information for designating a video condition, and

the traveling video search means acquires a traveling video satisfying the video condition from among the traveling videos captured by each of the vehicles traveling in one or more sections included in the route.

### [Supplementary Note 11]

The traveling video providing apparatus according to Supplementary note 10, wherein

the traveling video search means acquires a latest traveling video among the plurality of traveling videos when there are a plurality of traveling videos satisfying the video condition in the traveling video database.

### [Supplementary Note 12]

A traveling video providing method comprising:

searching, when a video distribution request including information designating a route is received from a user, a traveling video database configured to store traveling videos captured by a plurality of vehicles and position information about positions where the traveling videos are captured, and acquiring a traveling video(s) captured by vehicles traveling in one or more sections included in the designated route;

synthesizing the traveling video of each section included in the route; and

distributing the synthesized traveling video to a user apparatus as the traveling video when a vehicle travels along the route.

### [Supplementary Note 13]

A non-transitory computer readable medium storing a program for causing a computer to execute processing of:

searching, when a video distribution request including information designating a route is received from a user, a traveling video database configured to store traveling videos captured by a plurality of vehicles and position information about positions where the traveling videos are captured, and acquiring a traveling video(s) captured by vehicles traveling in one or more sections included in the designated route;

synthesizing the traveling video of each section included in the route; and

distributing the synthesized traveling video to a user apparatus as the traveling video when a vehicle travels along the route.

### REFERENCE SIGNS LIST

10, 100: TRAVELING VIDEO PROVIDING SYSTEM
11, 120: VIDEO COLLECTION SERVER
12, 130: TRAVELING VIDEO DATABASE
13, 140: VIDEO PROVIDING SERVER
14, 150: USER APPARATUS
31: TRAVELING VIDEO SEARCH MEANS
32: TRAVELING VIDEO SYNTHESIS MEANS
33: VIDEO DISTRIBUTION MEANS
141: REQUEST RECEPTION UNIT
142: TRAVELING VIDEO SEARCH UNIT
143: TRAVELING VIDEO SYNTHESIS UNIT
144: VIDEO TRANSMISSION UNIT

What is claimed is:

1. A traveling video providing system comprising:
a video collection server configured to receive traveling videos captured by a plurality of vehicles and store the traveling videos and position information in a traveling video database, the position information being about positions where the traveling videos are captured;
a video providing server configured to receive a video distribution request including information designating a route and distribute route traveling videos to a user, the route traveling videos being the traveling videos captured when a vehicle travels along the route designated in the video distribution request; and
a user apparatus configured to receive and display the distributed route traveling video, wherein
the video providing server comprises:
at least one memory storing instructions, and
at least one processor configured to execute the instructions to:
search the traveling video database when the video distribution request is received from the user, and acquire the traveling video(s) captured by the vehicle traveling in each of one or more sections included in the designated route;
synthesize the traveling video of each section included in the route; and
distribute the synthesized traveling video to the user apparatus as the route traveling videos.

2. The traveling video providing system according to claim 1, wherein
the video distribution request further includes information for designating a video condition, and
the at least one processor is configured to execute the instructions to acquire a traveling video satisfying the video condition from among the traveling videos captured by each of the vehicles traveling in one or more sections included in the route.

3. The traveling video providing system according to claim 2, wherein
the video conditions include at least one of a vehicle type, weather, a time period, a season, or a traveling direction.

4. The traveling video providing system according to claim 2, wherein
the at least one processor is configured to execute the instructions to acquire a latest traveling video among the plurality of traveling videos when there are a plurality of traveling videos satisfying the video condition in the traveling video database.

5. The traveling video providing system according to claim 1, wherein
the at least one processor is configured to execute the instructions to divide the route into a plurality of sections and acquire the traveling video for each section from the traveling video database.

6. The traveling video providing system according to claim 5, wherein
the at least one processor is configured to execute the instructions to divide the route into a plurality of sections at each branch point.

7. The traveling video providing system according to claim 1, wherein
the user apparatus includes a wearable or head-mounted display apparatus.

8. The traveling video providing system according to claim 1, wherein
the at least one processor is configured to execute the instructions to perform image processing for changing a viewpoint of the video on the traveling video of one section, and synthesize the traveling video of the one section having the changed viewpoint with the traveling video of another section.

9. A traveling video providing apparatus comprising:
at least one memory storing instructions, and
at least one processor configured to execute the instructions to:
search, when a video distribution request including information designating a route is received from a user, a traveling video database configured to store traveling videos captured by a plurality of vehicles and position information, the position information being about positions where the traveling videos are captured, and acquire a traveling video(s) captured by vehicles traveling in one or more sections included in the designated route;
synthesize the traveling video of each section included in the route; and
distribute the synthesized traveling video to a user apparatus as route traveling videos, the route traveling videos being the traveling videos captured when a vehicle travels along the route.

10. The traveling video providing system according to claim 9, wherein
the video distribution request further includes information for designating a video condition, and
the at least one processor is configured to execute the instructions to acquire a traveling video satisfying the video condition from among the traveling video captured by each of the vehicles traveling in one or more sections included in the route.

11. The traveling video providing apparatus according to claim 10, wherein
the at least one processor is configured to execute the instructions to acquire a latest traveling video among the plurality of traveling videos when there are a plurality of traveling videos satisfying the video condition in the traveling video database.

12. A traveling video providing method comprising:
searching, when a video distribution request including information designating a route is received from a user, a traveling video database configured to store traveling videos captured by a plurality of vehicles and position information, the position information being about positions where the traveling videos are captured, and acquiring a traveling video(s) captured by vehicles traveling in one or more sections included in the designated route;
synthesizing the traveling video of each section included in the route; and
distributing the synthesized traveling video to a user apparatus as route traveling videos, the route traveling videos being the traveling videos captured when a vehicle travels along the route.

13. (canceled)
